(19) United States
(12) Patent Application Publication
(10) Pub. No.: US 2014/0299099 A1
(43) Pub. Date: Oct. 9, 2014

(54) Internal Combustion Engine

(71) Applicant: Yamabiko Corporation, Tokyo (JP)

(72) Inventors: Takuo Yoshizaki, Tokyo (JP); Shirou Yamaguchi, Tokyo (JP)

(73) Assignee: Yamabiko Corporation, Tokyo (JP)

(21) Appl. No.: 14/243,910

(22) Filed: Apr. 3, 2014

(30) Foreign Application Priority Data
Apr. 5, 2013 (JP) 2013-079983

(51) Int. Cl. F02M 7/10

(52) U.S. Cl. CPC F02M 7/10
USPC 123/438

(57) ABSTRACT

A main nozzle (38) of a carburetor (10) communicates with a metering chamber (26) through a first fuel feeding passage (44) originally included in the carburetor and a first additional fuel feeding passage (46). The first additional fuel feeding passage (46) includes a flow rate adjusting valve (48). The flow rate adjusting valve (48) is driven by a solenoid actuator (50). The solenoid actuator (50) is controlled on the basis of engine speed.

### FIELD OF THE INVENTION

The present invention relates to an internal combustion engine including a carburetor and, more particularly, to an engine having a relatively small displacement mounted on a working machine.

### BACKGROUND OF THE INVENTION

An electrical control of recent internal combustion engines has progressed. For example, an automobile engine performs precise engine control on the basis of physical quantities detected by a large number of sensors. By this electrical control, fuel consumption of the automobile engine is greatly reduced and emission performance is greatly improved.

In a working machine mounted with an engine having a relatively small displacement, in general, a carburetor is still adopted even now (Japanese Patent Laid-Open No. 2010-174773 (Patent Literature 1)). To control a flow rate of fuel fed to an intake passage of the engine, the carburetor skillfully uses negative pressure generated in the intake passage (Japanese Patent Laid-Open No. 2009-209691 (Patent Literature 2), Japanese Patent Laid-Open No. H6-33723 (Patent Literature 3), Japanese Patent Laid-Open No. 562-55449 (Patent Literature 4), Japanese Patent Laid-Open No. 2005-2887 (Patent Literature 5), Japanese Patent Laid-Open No. 2007-77812 (Patent Literature 6), and Japanese Patent Laid-Open No. 2012-67770 (Patent Literature 7)). Patent Literatures 2 and 3 disclose carburetors of a throttle valve type. Patent Literatures 4 to 7 disclose carburetors of a rotary valve type. Both of the carburetors of the throttle valve type and the rotary valve type suck out fuel to an intake passage using negative pressure generated in the intake passage to thereby feed the fuel to the intake passage.

Development for electronic control is also progressing in the small displacement engine. However, since there is a strong demand for a reduction in the weight of the working machine, it is practically difficult to adopt precise engine control performed by using various sensors as in the automobile engine.

U.S. Pat. No. 7,493,889 B2 (Patent Literature 8) discloses a control method for a two-stroke internal combustion engine suitable for a working machine such as a chain saw, a trimmer, or a power blower. Specifically, the engine disclosed in Patent Literature 8 includes a speed sensor configured to detect an engine speed, a solenoid configured to drive a flow rate control valve disposed in a fuel feed passage for feeding a gas mixture to an intake passage, and electronic control means for controlling the solenoid according to the speed sensor. The engine disclosed in Patent Literature 8 includes, as in the past, near a throttle valve, a main nozzle for feeding the fuel to the intake passage and first to third fuel ejection ports of a slow system. The engine disclosed in Patent Literature 8 includes a fuel pump operating with internal pressure of a crank chamber. The fuel pump pumps up the fuel in a fuel tank and feeds the fuel to the main nozzle and the fuel ejection ports of the slow system.

In the engine of Patent Literature 8, as in the conventional engine including the carburetor, the fuel is fed from the first slow system port to the intake passage during idling. When the throttle vale is opened, the fuel is fed to the intake passage from the second slow system port as well. When the valve is further opened, the fuel is fed to the intake passage from the third slow system port as well. In a high speed range of the engine, the fuel is fed to the intake passage from the main nozzle as well. In the high speed range, the engine operates with the fuel substantially fed from the main nozzle.

The engine disclosed in Patent Literature 8 feeds the fuel pumped up from the fuel tank by the fuel pump to the intake passage irrespective of the negative pressure generated in the intake passage. The engine controls the solenoid on the basis of the engine speed and substantially controls, with the solenoid, a flow rate of the fuel fed to the intake passage.

### SUMMARY OF THE INVENTION

It is certain that the engine speed is a main physical quantity for engine control. However, detection of other physical quantities is also necessary to perform precise engine control. Even if a fuel feeding amount (a flow rate of the fuel ejected to the intake passage) is controlled depending on only the engine speed as disclosed in Patent Literature 3, it is difficult to optimize an air-fuel ratio with the control. Further, it is difficult to optimally tracking control of the engine in a transition region at the time when the throttle valve is rapidly opened, engine performance under an intermediate load, and the like. It goes without saying that, even in the engine having the relatively small displacement mounted on the working machine, it can be expected that the tendency of computerization will further increase in future.

However, currently, it is necessary to incorporate a plurality of sensors in order to detect various physical quantities. This is an unrealistic option based on a viewpoint of a reduction in the weight of the working machine. When the present situation is kept in mind, it can be said that the method of controlling the engine on the basis of the engine speed, which is a most basic physical quantity in the engine control, as proposed by Patent Literature 3 is a best measure that can be selected in the present situation.

Incidentally, for the working machine incorporating an engine, engine adjustment is performed at a stage when the working machine is shipped from a factory where the engine is manufactured. That is, the working machine is sold after the engine adjustment is performed to set the engine in an optimum operation state as designed. In the engine mounted with a carburetor, the engine adjustment is performed by manually adjusting a needle valve.

However, working environments of users are various. Some users perform work in a highland and other users perform work in a high temperature area or a low temperature area. Quality of fuel is not fixed. To cope with this problem, it is sufficient to ask the user's help. That is, the user may adjust the needle valve and set the engine in a most preferable operation state matching a work environment. However, it is troublesome to perform adjustment of the carburetor in each of work sites. Amid an increasing demand for, in particular, exhaust gas purification and a further reduction in fuel consumption, there is an increasing need to precisely perform the carburetor adjustment.

It is an object of the present invention to provide an internal combustion engine that can improve adaptability to an environmental variation.

It is another object of the present invention to provide an internal combustion engine that can improve adaptability to an environmental variation while keeping a simple configuration without incorporating a plurality of sensors.

It is still another object of the present invention to provide an internal combustion engine that can optimize an air-fuel ratio in an engine high speed range.

The working machine is used in a full-throttle state. That is, an operator performs work in a state in which a throttle valve is fully opened. In the history of the carburetor, the carburetor has been variously improved on the premise that the throttle valve is used in the fully opened state. It is considered that the carburetor has been matured through the long history. The inventors devised the present invention as a result of, keeping in mind a form of use of the working machine, conducting various studies based on a viewpoint whether it is possible to advance computerization of engine control while using the carburetor that was technically matured.

According to the present invention, the technical object is attained by providing an internal combustion engine including a carburetor having a first fuel ejection port for feeding fuel to an intake passage, the carburetor feeding the fuel to the intake passage by sucking out the fuel from the first fuel ejection port to the intake passage with negative pressure around the first fuel ejection port generated by an airflow in the intake passage, the internal combustion engine including:

a metering chamber for accumulating the fuel pumped up from a fuel tank;

a first fuel feeding passage for feeding the fuel in the metering chamber to the first fuel ejection port;

a second fuel ejection port arranged in the intake passage for ejecting the fuel to the intake passage with negative pressure around the second fuel ejection port generated by the airflow in the intake passage;

a first additional fuel feeding passage coupled to the second fuel ejection port for feeding the fuel in the metering chamber to the second fuel ejection port;

a flow rate adjusting valve provided in the first additional fuel feeding passage for adjusting a flow rate of the fuel flowing through the first additional fuel feeding passage;

engine speed detecting means for detecting engine speed; and

electronic control means for receiving a signal from the engine speed detecting means to control an opening degree of the flow rate adjusting valve.

The carburetor may be the carburetor of the throttle valve type explained above or may be the carburetor of the rotary valve type. The carburetor of the throttle valve type includes a plurality of fuel ejecting ports. The plurality of fuel ejection ports include a fuel ejection port of a slow system located near a butterfly valve (called “throttle valve”), which controls an output of the engine, and a main nozzle located in a venturi section of the intake passage. The fuel is fed to the slow system fuel ejection port and the main nozzle from the metering chamber, which accumulates the fuel pumped up from the fuel tank. The “first fuel ejection port” in the present invention corresponds to the main nozzle in the case of the carburetor of the throttle valve type.

The carburetor of the rotary valve type includes a valve body having a cylindrical shape (“throttle valve”) and controls an output of the engine according to rotation of the valve body. The carburetor includes a nozzle on a rotation axis of the cylindrical valve body. A valve rod displaced up and down is inserted into the nozzle. The valve rod moves up and down in association with a rotation angle of the cylindrical valve body and controls an effective opening area of an ejection port of the nozzle. The fuel is fed to the nozzle from the metering chamber, which accumulates the fuel pumped up from the fuel tank. When the carburetor in the present invention is the carburetor of the rotary valve type, the nozzle corresponds to the “first fuel ejection port” in the present invention.

The internal combustion engine of the present invention is an engine having a relatively small displacement mounted on a working machine and is typically a two-stroke engine. The working machine includes a chain saw, a trimmer, a power blower, a pump of an engine type, a small generator, an agrochemical sprayer and so on.

The internal combustion engine of the present invention includes, besides the first fuel feeding passage for feeding the fuel to the first fuel ejection port originally included in the conventional carburetor, the first additional fuel feeding passage for feeding the fuel to the second fuel ejection port. The fuel is fed to the intake passage through the two passages, that is, the first fuel feeding passage and the first additional fuel feeding passage. The first and second fuel ejection ports may be configured by a common ejection port or may be configured by ejection ports independent from each other. It goes without saying that it is reasonable in reducing manufacturing costs to couple, using the nozzle included in the conventional carburetor (the nozzle corresponds to the main nozzle in the carburetor of the throttle valve type, and to the nozzle in the carburetor of the rotary valve type), the first additional fuel feeding passage to the nozzle originally included in the carburetor.

An amount of the fuel fed to the intake passage through the first fuel feeding passage of the carburetor is referred to as “fixed fuel feeding amount” and an amount of the fuel fed to the intake passage through the first additional fuel feeding passage is referred to as “electronically-controlled fuel feeding amount”. The adjustment with respect to an environmental variation is performed according to the electronically-controlled fuel feeding amount. In the engine high speed range, a ratio of the fixed fuel feeding amount and the electronically-controlled fuel feeding amount is arbitrary. For example, the ratio of the fixed fuel feeding amount and the electronically-controlled fuel feeding amount may be 50:50 or may be 60:40 or 80:20. This ratio is substantially determined by an effective passage sectional area of the first fuel feeding passage for specifying the fixed fuel feeding amount, an effective passage sectional area of the first additional fuel feeding passage for specifying the electronically-controlled fuel feeding amount, and a reference opening degree of the flow rate adjusting valve. As the ratio of the electronically-controlled fuel feeding amount increases, correction range by the electronically-controlled fuel feeding amount expands. Therefore, it is possible to sensitively perform control with respect to a change in the air-fuel ratio due to the environmental variation.

When the reference opening degree of the flow rate adjusting valve, that is, the opening degree of the flow rate adjusting valve in design on factory shipment is set to, for example, an opening degree of 50%, in the site, it is likely that the flow rate adjusting valve can be electronically adjusted in a range of the opening degree of 50% to 0%. Further, it is likely that the flow rate adjusting valve can be electronically adjusted in a range of the opening degree of 50% to 100%. It goes without saying that the reference opening degree of the flow rate adjusting valve is arbitrary.

That is, the internal combustion engine of the present invention performs adjustment, that is, correction of a fuel feeding amount in use in an environment different from an environment on engine shipment through electronic control while using, as it is, basic fuel feeding performance in idling, the low speed region, the intermediate speed region, and the high speed range originally included in the conventional carburetor. Therefore, according to the present invention, it is possible to improve adaptability to an environmental variation by applying relatively simple electronic control to the mechanical carburetor while keeping a simple configuration without requiring a detection signal other than the engine speed.

Further objects, functions and effects of the present invention will be made obvious from detailed explanation of the preferred embodiments.

### BRIEF DESCRIPTION OF THE DRAWINGS

FIG. 1 is a diagram for schematically explaining a two-stroke single-cylinder engine in an embodiment;

FIG. 2 is a configuration diagram of a carburetor (a throttle valve type) included in an engine in a first embodiment;

FIG. 3 is a configuration diagram of a carburetor (the throttle valve type) included in an engine in a second embodiment;

FIG. 4 is a configuration diagram of a carburetor (the throttle valve type) included in an engine in a third embodiment; and

FIG. 5 is a configuration diagram of a carburetor (the rotary valve type) included in an engine in a fourth embodiment.

### DETAILED DESCRIPTION OF THE INVENTION

Preferred embodiments of the present invention are explained below on the basis of the accompanying drawings.

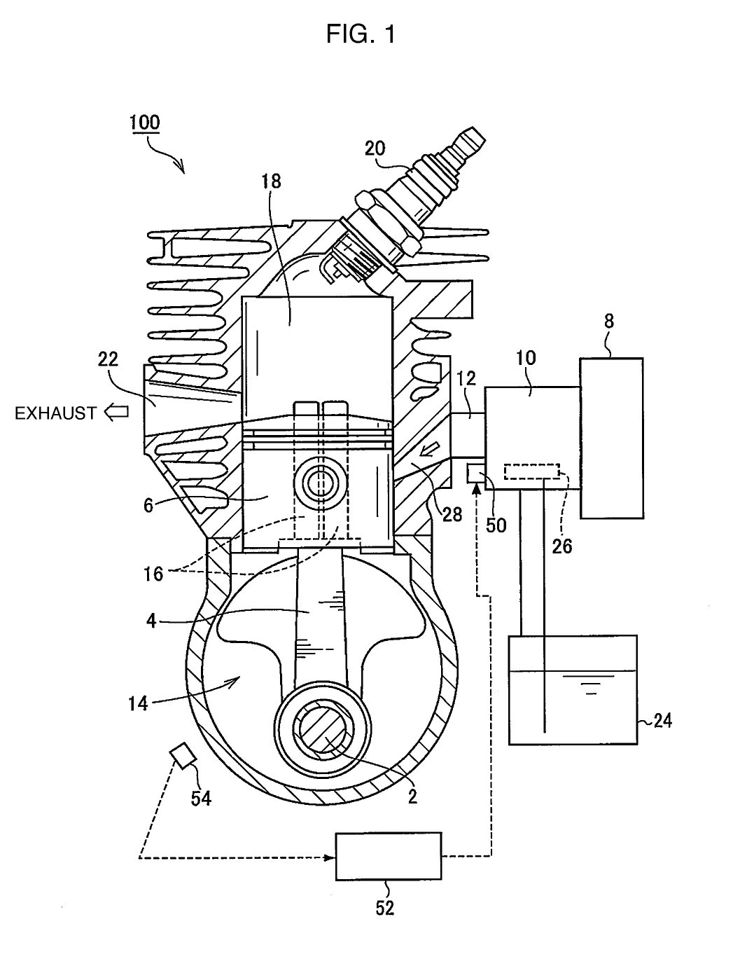

Referring to FIG. 1, reference numeral 100 represents an internal combustion engine. The internal combustion engine 100 is an air-cooled two-stroke single-cylinder engine. The engine 100 is an engine having a relatively small displacement and is mounted on a portable working machine such as a chain saw, a trimmer, a power blower, a pump of an engine type, a small power generator, or an agrochemical sprayer.

The engine 100 includes a crankshaft 2, which is an engine output shaft. The crankshaft 2 is coupled to a piston 6 by a connecting rod 4. A reciprocating motion of the piston 6 is converted into a rotary motion by the crankshaft 2.

An intake system of the engine 100 is configured by an air cleaner 8, a carburetor 10, and a coupling pipe (an insulator) 12. The intake air filtered by the air cleaner 8 is mixed with a fuel component atomized by the carburetor 10 to be a gas mixture. The gas mixture is charged into a combustion chamber 18 through a scavenging passage 16 passing via a crank chamber 14 of the engine 100.

The gas mixture filled in the combustion chamber 18 is compressed by the piston 6 ascending (a compression stroke). The gas mixture is ignited by an ignition plug 20 near a top dead center (T.D.C.) and burned, whereby the piston 6 descends (an expansion stroke). In a process in which the piston 6 descends, an exhaust port 22 opens and then a scavenging port opens. The gas mixture in the crank chamber 14 is led into the combustion chamber 18 through the scavenging passage 16 communicating with the scavenging port. Scavenging of the combustion chamber 18 is performed by the gas mixture (a scavenging stroke). In a process in which the piston 6 ascends from a bottom dead center (B.D.C.), the gas mixture is charged into the crank chamber 14 through an intake port 28. A mechanism of the two-stroke internal combustion engine 100 in the embodiment is the same as the conventional mechanism. Therefore, detailed explanation of the mechanism is omitted.

### First Embodiment

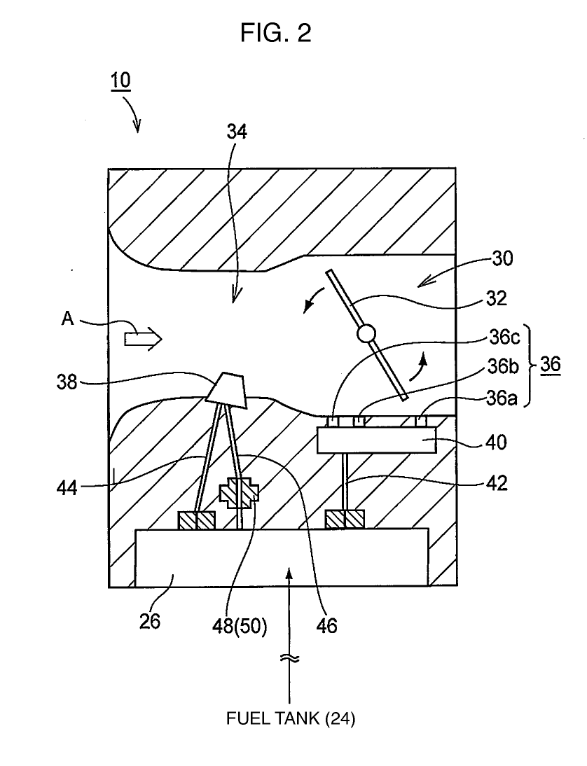

### FIG. 2

The carburetor 10 included in the first embodiment is a carburetor of a throttle valve type. The detailed structure of the carburetor of the throttle valve type is explained in detail in, for example, Patent Literature 2. Therefore, the full text of Patent Literature 2 is incorporated herein for reference. As explained in Patent Literature 2, the carburetor 10 of the throttle valve type includes a metering chamber 26 configured to accumulate fuel pumped up from a fuel tank 24.

FIG. 2 shows an intake passage 30 included in the carburetor 10. In the figure, an arrow A indicates a flowing direction of the intake air. A throttle valve 32 is disposed in the intake passage 30. The throttle valve 32 is opened and closed on the basis of throttle operation by a user. An output of the engine 100 is controlled according to an opening degree of the throttle valve 32. The intake passage 30 includes a venturi section 34 of a fixed type located on an upstream side of the throttle valve 32.

Like the conventional carburetor, the carburetor 10 of the throttle valve type includes a plurality of fuel ejection ports opened to the intake passage 30. Specifically, the plurality of fuel ejection ports included in the carburetor 10 include a fuel ejection port 36 of a slow system located near the throttle valve 32 and a main nozzle 38 located in the venturi section 34. The fuel ejection port 36 of the slow system is configured by three slow system ports 36a, 36b, and 36c. The three slow system ports 36a, 36b, and 36c are located in the flowing direction A of the intake air spaced apart from one another. The three slow system ports 36a, 36b, and 36c are referred to as first slow system port 36a, second slow system port 36b, and third slow system port 36c in order from a downstream side to an upstream side in the flowing direction A of the intake air. Fuel is sucked out from the first slow system port 36a to the intake passage 30 during idling in a state in which the throttle valve 32 is closed. When the throttle valve 32 starts to open, the fuel is also sucked out from the second slow system port 36b to the intake passage 30. When the throttle valve 32 opens more, the fuel is also sucked out from the third slow system port 36c to the intake passage 30.

In an engine high speed range, the throttle valve is in a full open state. The fuel is sucked out from the main nozzle 38 to the intake passage 30 by negative pressure generated in the venturi section 34. In the engine high speed range, substantially the entire amount of the fuel charged into the intake passage 30 is fed from the main nozzle 38.

Referring to FIG. 2 again, the fuel is fed to the main nozzle 38 from the metering chamber 26. The fuel is fed to the first to third fuel ejection ports 36a to 36c of a slow system from a slow system chamber 40. The fuel is fed to the slow system chamber 40 from the metering chamber 26.

That is, the first to third slow system ports 36a to 36c communicate with the slow system chamber 40. The slow system chamber 40 communicates with the metering chamber 26 via a slow system fuel feeding passage 42. On the other hand, the main nozzle 38 communicates with the metering chamber 26 through a first fuel feeding passage 44 originally included in the carburetor 10.

The main nozzle 38 further communicates with the metering chamber 26 through a first additional fuel feeding passage 46. A flow rate adjusting valve 48 is interposed in the first additional fuel feeding passage 46. In this embodiment, the flow rate adjusting valve 48 is driven by a solenoid actuator 50 (FIG. 1). The solenoid actuator 50 is controlled by a control unit 52 configured by, for example, a microcomputer (FIG. 1). Engine speed is input to the control unit 52 from an engine speed detecting unit 54. The control unit 52 generates a driving control signal based on the engine speed and supplies the driving control signal to the solenoid actuator 50.

The solenoid actuator 50 receives the driving control signal and operates. The flow rate adjusting valve 48 is controlled to a state, that is an opening degree, corresponding to the engine speed by the solenoid actuator 50. In this embodiment, the opening degree of the flow rate adjusting valve 48 is adjusted at a valve opening frequency per unit time. It goes without saying that other physical quantities, for example, outdoor temperature and atmospheric pressure may be detected in order to perform the control of the solenoid actuator 50. The opening degree of the flow rate adjusting valve 48 may be controlled according to these parameters.

The engine speed detecting unit 54 detects engine speed with an electromotive force from an ignition coil known in the past. That is, a permanent magnet is set in a flywheel coupled to the crankshaft 2. The detection of the engine speed is performed according to an alternating voltage generated between the permanent magnet and the fixed ignition coil. That is, the engine speed is detected according to the frequency of a sine-wave alternating voltage generated between the coil and the magnet.

In the engine high speed range, the fuel is mainly sucked out from the main nozzle 38 to the intake passage 30. In this embodiment, in the engine high speed range, the fuel is fed to the main nozzle 38 through two passages, i.e., the first fuel feeding passage 44 and the first additional fuel feeding passage 46. A flow rate of the first fuel feeding passage 44 is fixed as in the past. On the other hand, a flow rate of the first additional fuel feeding passage 46 is variable by the electronically-controlled flow rate adjusting valve 48.

The engine 100 including the carburetor 10 in the first embodiment or a working machine mounted with the engine 100 is subjected to various adjustments before shipped from a factory. Adjustment of an air-fuel ratio in the engine high speed range is one of the adjustments. In the engine adjustment before the shipment, the flow rate adjusting valve 48 is set such that a reference opening degree thereof is a median in an adjustment range. When the user gets the engine or machine, the user does not need to perform adjustment of a needle valve required in the conventional engine for example, in performing work in a highland or a low atmospheric pressure area. When the user works under an environment in low atmospheric pressure, the opening valve frequency of the flow rate adjusting valve 48 of the engine 100 is reduced by electronic control adjustment. Consequently, the fuel feeding amount in the engine high speed range is narrowed down, and the gas mixture sucked by the engine 100 is automatically adjusted to an air-fuel ratio suitable for the environment.

### Second Embodiment

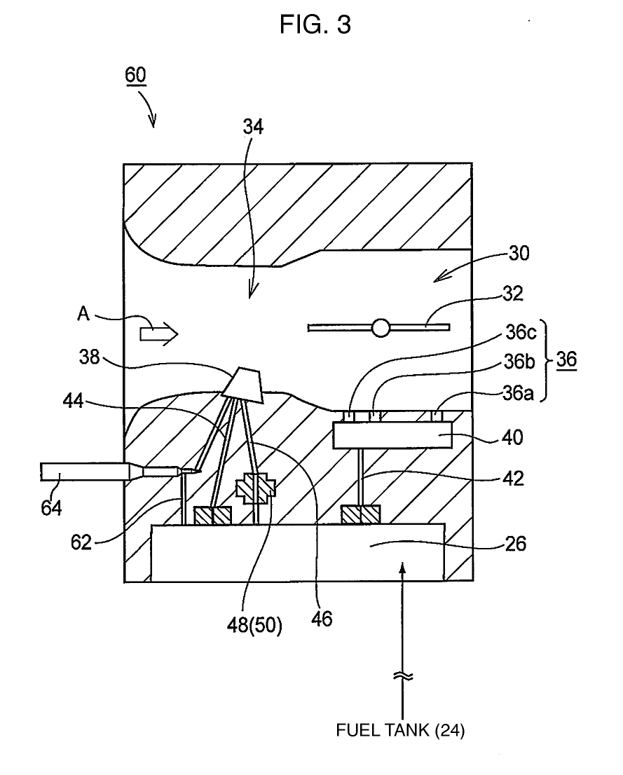

### FIG. 3

FIG. 3 shows a diagram for explaining a carburetor 60 included in a second embodiment. The carburetor 60 shown in FIG. 3 is also the carburetor of the throttle valve type. In the explanation of the carburetor 60 shown in FIG. 3, components same as the components of the carburetor 10 included in the first embodiment (FIG. 2) are denoted by the same reference numerals and signs and explanation of the components is omitted. Characteristic portions of the carburetor 60 shown in FIG. 3 are explained below.

Referring to FIG. 3, a second additional fuel feeding passage 62 is coupled to the main nozzle 38 and communicates with the metering chamber 26. An ejection port of the second additional fuel feeding passage 62 may be a third fuel ejection port separately provided from the main nozzle 38 and/or the first additional fuel feeding passage 46. It goes without saying that the third fuel ejection port is positioned in the venturi section 34.

In the second additional fuel feeding passage 62, a manual adjustment valve (a needle valve) 64 for adjusting an amount of fuel passing through the second additional fuel feeding passage 62 is provided. The adjustment by the manual adjustment valve 64 can be manually performed by the user or an agent of a manufacturer.

In the carburetor 60 in the second embodiment, the fuel is fed to the main nozzle 38 through three passages, i.e., the first fuel feeding passage 44, the first additional fuel feeding passage 46, and the second additional fuel feeding passage 62 in the engine high speed range. A flow rate of the first fuel feeding passage 44 is fixed as in the past. On the other hand, a flow rate of the first additional fuel feeding passage 46 is variable by the electronically-controlled flow rate adjusting valve 48. A flow rate of the second additional fuel feeding passage 62 can be adjusted by the manual adjustment valve 64.

An amount of the fuel fed to the intake passage 30 through the first fuel feeding passage 44 is referred to as “fixed fuel feeding amount”, an amount of the fuel fed to the intake passage 30 through the first additional fuel feeding passage 46 is referred to as “electronically-controlled fuel feeding amount”, and an amount of the fuel fed to the intake passage 30 through the second additional fuel feeding passage 62 is referred to as “manually-adjusted fuel feeding amount”. It is desirable to add adjustment of the “manually-adjusted fuel feeding amount” to adjustment of an air-fuel ratio before shipment. That is, in the engine high speed range, it is desirable to operate the needle valve 64 to perform flow rate adjustment for the second additional fuel feeding passage 62 such that a reference value of an opening degree of the electronically-controlled flow rate adjusting valve 48 is a median in an adjustment range. In the engine high speed range, a ratio of the fixed fuel feeding amount, the electronically-controlled fuel feeding amount, and the manually-adjusted fuel feeding amount is arbitrary. For example, as the ratio of the fixed fuel feeding amount, the electronically-controlled fuel feeding amount, and the manually adjusted fuel feeding amount, 60:20:20 can be illustrated. In a highland or a highland or a low atmospheric pressure area, the user can adjust the manual adjustment valve 64 in a valve closing direction. In this case, a basic flow rate of fuel feeding is defined with fuel concentration set by the manual adjustment. A fine adjustment portion is performed according to the “electronically-controlled fuel feeding amount”.

### Third Embodiment

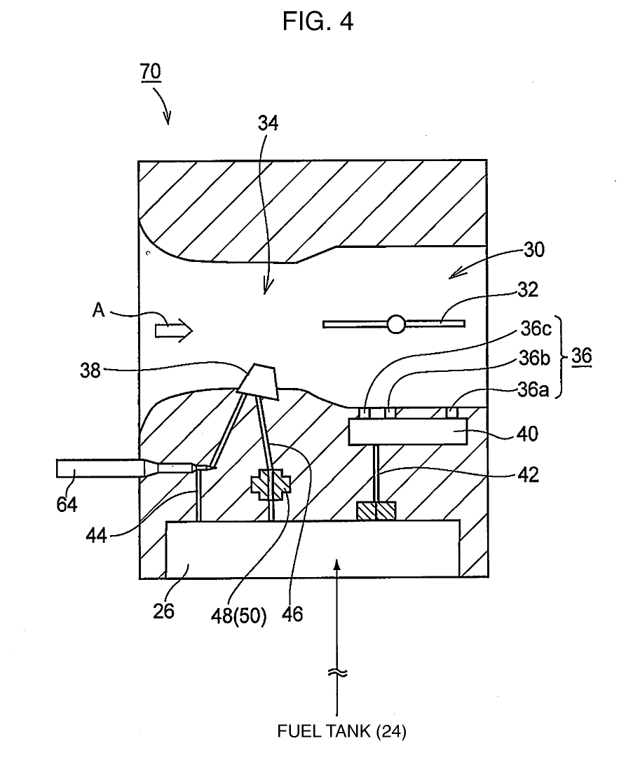

### FIG. 4

FIG. 4 shows a diagram for explaining a carburetor 70 included in a third embodiment. The carburetor 70 shown in FIG. 4 is also the carburetor of the throttle valve type. In explanation of the carburetor 70 shown in FIG. 4, components same as the components of the carburetor 10 shown in FIG. 2 and the carburetor 60 shown in FIG. 3 are denoted by the same reference numerals and signs and explanation of the components is omitted. Characteristic portions of the carburetor 70 shown in FIG. 4 are explained below.

Referring to FIG. 4, the first fuel feeding passage 44 and the first additional fuel feeding passage 46 are coupled to the main nozzle 38. The carburetor 70 is the same as the carburetor 10 in the first embodiment (FIG. 2) in this regard. An ejection port of the first fuel feeding passage 44 and an ejection port of the first additional fuel feeding passage 46 may be independent from each other. That is, the first additional fuel feeding passage 46 may include a dedicated ejection port separately from the main nozzle 38 of the first fuel feeding passage 44. It goes without saying that the dedicated ejection port is positioned in the venturi section 34.

The flow rate adjusting valve 48 of the electronic control type is interposed in the first additional fuel feeding passage 46. On the other hand, in the first fuel feeding passage 44, the manual adjustment valve (the needle valve) 64 explained in the second embodiment (FIG. 3) is provided. An amount of the fuel passing through the first additional fuel feeding passage 46 can be adjusted by the manual adjustment valve 64. As in the second embodiment, the adjustment by the manual adjustment valve 64 can be manually performed by the user or an agent of a manufacturer.

An amount of the fuel fed to the intake passage 30 through the first fuel feeding passage 44 is referred to as “manually-adjusted fuel feeding amount” and an amount of the fuel fed to the intake passage 30 through the first additional fuel feeding passage 46 is referred to as “electronically-controlled fuel feeding amount”. It is desirable to add adjustment of the “manually-adjusted fuel feeding amount” to adjustment of an air-fuel ratio before shipment. That is, in the engine high speed range, it is desirable to operate the needle valve 64 to perform flow rate adjustment for the first fuel feeding passage 44 such that a reference value of an opening degree of the electronically-controlled flow rate adjusting valve 48 is a median in an adjustment range. In the engine high speed range, a ratio of the electronically-controlled fuel feeding amount and the manually-adjusted fuel feeding amount is arbitrary: For example, as the ratio of the electronically-controlled fuel feeding amount and the manually-adjusted fuel feeding amount, 80:20 can be illustrated. In this embodiment, as in the embodiments explained above, adjustment required in work under the environment is performed according to the “electronically-controlled fuel feeding amount”. In a highland or a low atmospheric pressure area, the user may adjust the manual adjustment valve 64 to adjust the flow rate of the first fuel feeding passage 44 to a relatively small state. However, even when the user does not perform the adjustment, optimization of an air-fuel ratio with respect to an environmental variation is performed by electronic control of the “electronically-controlled fuel feeding amount”.

### Fourth Embodiment

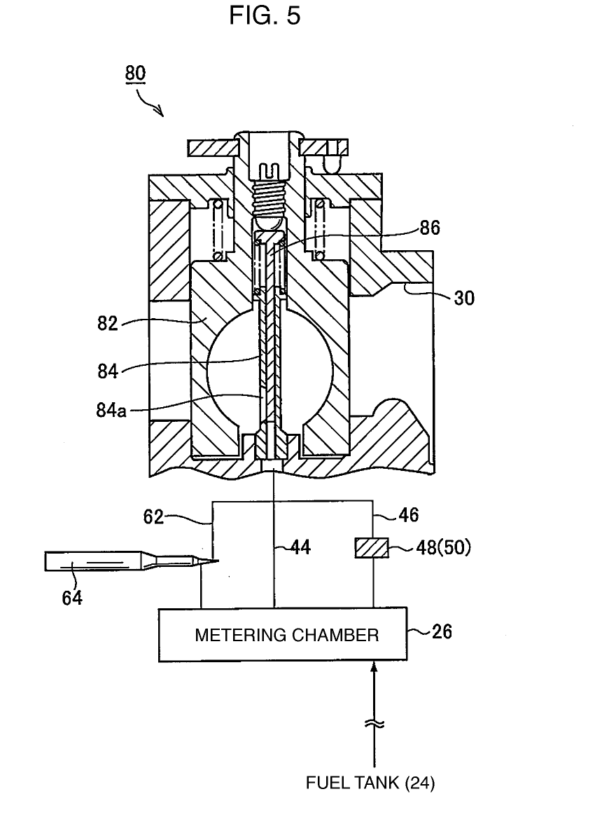

### FIG. 5

FIG. 5 shows a diagram for explaining a carburetor 80 included in a fourth embodiment. The carburetor 80 shown in FIG. 5 is a carburetor of a rotary valve type. The configuration of the carburetor of the rotary valve type is explained in detail in Patent Literature 4. Therefore, the full text of the disclosure of Patent Literature 4 is incorporated therein for reference.

Referring to FIG. 5, the rotary carburetor 80 includes a cylindrical throttle valve 82 as in the past. The throttle valve 82 can rotate around an axis thereof, whereby an engine output is controlled. A nozzle 84 is arranged on the axis of the throttle valve 82. The nozzle 84 includes an opening 84a on a sidewall thereof.

A valve rod 86 is inserted into the nozzle 84. The valve rod 86 can move up and down in association with a rotary motion around the axis of the throttle valve 82. An effective opening area of the nozzle opening 84a is controlled by moving up and down of the valve rod 86.

The fuel in the metering chamber 26 is fed to the nozzle 84. As a fuel feeding structure between the metering chamber 26 and the nozzle 84, in an example shown in FIG. 5, the structure adopted in the second embodiment (FIG. 3) is adopted. It goes without saying that the structure adopted in the first embodiment (FIG. 2) or the third embodiment (FIG. 4) may be adopted.

Referring to FIG. 5 again, the first fuel feeding passage 44, the first additional fuel feeding passage 46, and the second additional fuel feeding passage 62 communicate with the nozzle 84 originally included in the rotary carburetor 80. Fuel ejection ports of the first additional fuel feeding passage 46 and the second additional fuel feeding passage 62 may be configured as nozzles or ports separate from the nozzle 84. In the case of the rotary carburetor 80, the structure shown in FIG. 5 in which the first fuel feeding passage 44, the first additional fuel feeding passage 46, and the second additional fuel feeding passage 62 communicate with the common nozzle 84 would be most realistic.

In the rotary carburetor 80, the fuel is fed to the intake passage 30 through the nozzle 84 in operation states from idling to high speed. In this embodiment, control of the electronically-controlled flow rate adjusting valve 48 of the first additional fuel feeding passage 46 (opening degree control based on the engine speed) is limited to only the engine high speed range. In the other operation states (the idling, the low speed region, and the intermediate speed region), the opening degree is fixed (e.g., 50%). By this setting, it is possible to suppress fluctuation in an air-fuel ratio accompanying with an environmental variation in the engine high speed range by the control of the electronically-controlled flow rate adjusting valve 48. It goes without saying that the control of the electronically-controlled flow rate adjusting valve 48 of the first additional fuel feeding passage 46 (the opening degree control based on the engine speed) may be performed in the idling, the low speed region, and the intermediate speed region as well.

The embodiments of the present invention are explained above. The carburetor used in the engine 100 of the present invention is configured to be adaptable to an environmental variation without substantially changing the mechanism and the function of the conventional carburetor and by adding the electronic control typically performed using only engine speed as a detection value. Thus, it is possible to, while keeping a simple configuration including a limited sensor, in other words, while keeping a simple configuration without using a plurality of sensors, suppress fluctuation in an air-fuel ratio in the engine high speed range and a transient state and optimize an air-fuel ratio in operating the engine at high speed to perform work.

While the invention has been described with reference to the specific embodiment, it will be apparent to those skilled in the art that various changes and modifications can be made to the specific embodiment without departing from the spirit and scope of the invention as defined in the claims.

### REFERENCE SIGNS LIST

100 Engine
10 Carburetor (a throttle valve type) mounted on the engine in the first embodiment
26 Metering chamber
30 Intake passage of the carburetor
32 Throttle valve
34 Venturi section of the carburetor
36 Slow system fuel ejection port of the carburetor
38 Fuel ejection port (main nozzle)
44 First fuel feeding passage
46 First additional fuel feeding passage
48 Flow rate adjusting valve
50 Solenoid actuator
52 Electronic control unit
54 Engine speed detecting unit
60 Carburetor (the throttle valve type) included in the second embodiment
62 Second additional fuel feeding passage
64 Manual adjustment valve (needle valve)
70 Carburetor (the throttle valve type) included in the third embodiment
80 Carburetor (a rotary valve type) included in the fourth embodiment
84 Nozzle of the rotary carburetor
86 Valve rod of the rotary carburetor

What is claimed is:

1. An internal combustion engine including a carburetor having a first fuel ejection port for feeding fuel to an intake passage, the carburetor feeding the fuel to the intake passage by sucking out the fuel from the first fuel ejection port to the intake passage with negative pressure around the first fuel ejection port generated by an airflow in the intake passage, the internal combustion engine comprising:
a metering chamber for accumulating the fuel pumped up from a fuel tank;
a first fuel feeding passage for feeding the fuel in the metering chamber to the first fuel ejection port;
a second fuel ejection port arranged in the intake passage for ejecting the fuel to the intake passage with negative pressure around the second fuel ejection port generated by the airflow in the intake passage;
a first additional fuel feeding passage coupled to the second fuel ejection port for feeding the fuel in the metering chamber to the second fuel ejection port;
a flow rate adjusting valve provided in the first additional fuel feeding passage for adjusting a flow rate of the fuel flowing through the first additional fuel feeding passage;
engine speed detecting means for detecting engine speed; and
electronic control means for receiving a signal from the engine speed detecting means to control an opening degree of the flow rate adjusting valve.

2. The internal combustion engine according to claim 1, wherein the first fuel ejection port and the second fuel ejection port are configured by a common ejection port.

3. The internal combustion engine according to claim 2, wherein the carburetor is a carburetor of a throttle valve type.

4. The internal combustion engine according to claim 2, wherein the carburetor is a carburetor of a rotary valve type.

5. The internal combustion engine according to claim 1, further comprising:
a first fuel feeding passage configured to cause the first fuel ejection port and the metering chamber to communicate with each other; and
a manual adjustment valve provided in the first fuel feeding passage, wherein
a flow rate of the fuel flowing through the first fuel feeding passage can be adjusted by operating the manual adjustment valve.

6. The internal combustion engine according to claim 1, further comprising:
a third fuel ejection port arranged to face a venturi section in the intake passage;
a second additional fuel feeding passage configured to cause the third fuel ejection port and the metering chamber to communicate with each other; and
a manual adjustment valve provided in the second additional fuel feeding passage, wherein
a flow rate of the fuel flowing through the second additional fuel feeding passage can be adjusted by operating the manual adjustment valve.

7. The internal combustion engine according to claim 6, wherein the third fuel ejection port is common to at least one ejection port of the first fuel ejection port and the second fuel ejection port.

8. The internal combustion engine according to claim 1, wherein the internal combustion engine is a two-stroke engine.
